(19) United States
(12) Patent Application Publication
(10) Pub. No.: US 2022/0038567 A1
(43) Pub. Date: Feb. 3, 2022

(54) MOBILE INTEGRATED BIOMETRIC APPARATUS

(71) Applicant: InCadence Strategic Solutions Corporation, Manassas, VA (US)

(72) Inventors: Anthony S. lasso, Middleburg, VA (US); Daniel lasso, Towaco, NJ (US); John P. Mclntyre, Stephens City, VA (US); Ashley Thompson, Warrenton, VA (US)

(73) Assignee: InCadence Strategic Solutions Corporation, Manassas, VA (US)

(21) Appl. No.: 17/279,743

(22) PCT Filed: Sep. 25, 2019
(86) PCT No.: PCT/US2019/052912

§ 371 Date: Mar. 25, 2021

Related U.S. Application Data
(60) Provisional application No. 62/737,342, filed on Sep. 27, 2018.

(51) Int. Cl. H04M 1/67; G06F 1/16; H04M 1/72409; G06K 9/00

(52) U.S. Cl. CPC H04M 1/67; G06F 1/1632; G06F 21/32; G06K 9/00892; H04M 1/72409

(57) ABSTRACT

A mobile biometric apparatus includes a module and a first frame supporting a mobile terminal. The module includes a second frame supporting a biometric sensor having a sensing surface oriented in the same direction as a display screen of the mobile terminal. The module further includes a coupler and a connector. The coupler removably couples the first and second frames. The connector delivers powers and signals between the mobile terminal and biometric sensor. The signals include biometric information obtained by the biometric sensor. The connector may include a plug of a type configured to be inserted into the port of a smart phone, table, or another type of mobile terminal.

### BACKGROUND OF THE INVENTION

### Field of the Invention

One or more embodiments described herein relate to biometric devices and applications.

### Description of Related Art

The security threats that exist today are perhaps more serious than ever before. These threats extend not only to individuals but also to organizations, corporations, and whole nations. The efforts in place to preempt those threats have not always proven effective, often because of delays or inadequate intelligence. As a result, efforts are continually being made to develop efficient tools to help security personnel in carrying out their jobs.

One tool that is gaining widespread appeal uses biometric data to identify terrorists, criminals, or other persons of interest. However, the processes that presently exist for collecting and processing biometric data are considered out of date. For example, biometric collection equipment and computer systems are often located at central facilities. This makes identity verification in the field impossible. Attempts have been made to make portable equipment, so that security officers can use them on site. However, this equipment is expensive, cumbersome, and prone to breaking.

### BRIEF SUMMARY OF THE INVENTION

These and other objects have been addressed by one or more embodiments described herein, which provide a mobile biometric apparatus that may be used in the field to collect one or more forms of biometric information from subjects of interest. The apparatus is integrated in that it may be coupled to a mobile information terminal that can exchange information wirelessly with remote servers for authentication and identity verification. The mobile biometric apparatus may therefore serve as a useful tool to field personnel in preempting dangerous threats or otherwise restricting access to protected areas and/or equipment.

In accordance with these or other embodiments, the mobile information terminal may be any one of a number commercially available terminals, such as but not limited to smart phones, tablets, and handheld computers.

In accordance with these or other embodiments, the mobile biometric apparatus may operate solely based on the power of the mobile information terminal. This may alleviate the need to perform a charging operation for the mobile biometric apparatus.

In accordance with these or other embodiments, the mobile biometric apparatus may be integrated to include one or multiple biometric sensors. When multiple sensors are included, the mobile biometric apparatus may be used, for example, by the military and intelligence communities in carrying out operations.

In accordance with these or other embodiments, the mobile biometric apparatus may acquire biometric information from those sensor(s) in a form compatible with private and/or government standards, including but not limited to the standards of the Federal Bureau of Investigation (FBI), various military branches, Homeland Security, Border Patrol, and police departments, to name a few.

In accordance with these or other embodiments, the biometric sensor(s) may be updated simultaneously and automatically when updating application software running on the mobile information terminal used to acquire, process, and communicate biometric information.

In accordance with these or other embodiments, the one or more biometric sensors may have sensing surfaces facing the same direction as a display screen of the mobile information terminal, thereby increasing the efficiency of use of the entire mobile biometric apparatus.

In accordance with these or other embodiments, the mobile biometric apparatus may include supporting features made from rigid materials that make the apparatus rugged and thus suitable for use in the field.

These or other embodiments described herein include a mobile biometric apparatus having a first frame to support a mobile terminal and a module including a second frame to support a first biometric sensor. The first biometric sensor has a sensing surface oriented in a same direction as a display screen of the mobile terminal. The module includes a coupler to removably couple the second frame to the first frame, and a connector to deliver power from the mobile terminal to the first biometric sensor and to exchange signals between the first biometric sensor and the mobile terminal. The signals include biometric information from the first biometric sensor. The connector includes a plug that is to be inserted into a port of the mobile terminal when the first frame is coupled to the second frame and separated from the port of the mobile terminal when the first frame is uncoupled from the second frame.

The plug may extend from a side surface of the module with no intervening cable. The first frame may have an upper surface which is coplanar with an upper surface of the second frame. The first case may support the mobile phone at a level coplanar with the first biometric sensor supported by the second case. The first biometric sensor may be powered based only on the power from the mobile terminal through the connector. The signals may include one or more control signals output from the mobile terminal to operate the first biometric sensor.

The second frame may be smaller than the first frame. The first frame and the second frame may be made of a polycarbonate material or another material that imparts resilience and rigidity to the frames, thereby making the entire apparatus ruggedized. The mobile terminal may be a smart phone, a tablet, a handheld computer, a personal digital assistant, or another type of terminal, for example, capable of running a biometric applications program. The first biometric sensor may be a fingerprint reader, palm reader, palm vein reader, an iris scanner, retina scanner, a microphone for voice recognition, a camera for recognition of a body part or body feature, or another type of biometric sensor.

The second frame of the module may support a second biometric sensor. The second biometric sensor may have a sensing surface oriented in the same direction as the display screen of the mobile terminal and the sensing surface of the first biometric sensor, or may be oriented in a different direction. The first and second biometric sensors may sense the same or different biometric information. The coupler may include one or more screws to mate, with threads of the first frame. The coupler may also include one or more wheels to turn the one or more screws to removably couple and uncouple the second frame to the first frame. The coupler may have a different structure in another embodiment.

In accordance with another embodiment, a mobile biometric module includes a first frame to support a biometric sensor, a coupler to removably couple the first frame to a second frame, and a connector to deliver power from a mobile terminal supported by the second frame to the biometric sensor. The first frame supports the biometric sensor so that a sensing surface of the biometric sensor is oriented in a same or different direction as a display screen of the mobile terminal. The connector delivers biometric information from the biometric sensor to the mobile terminal. The connector may include a plug that is to be inserted into a port of the mobile terminal. The plug may extend from a side surface of the module with no intervening cable.

The first frame may support the biometric sensor at a level coplanar with the mobile terminal in the second frame. The connector may carry one or more control signals from the mobile terminal to the first biometric sensor. The first frame may be made of a polycarbonate material. The mobile terminal may be a smart phone, a tablet, a handheld computer, a personal digital assistant, or another type of mobile terminal, for example, capable of running a biometric applications program. The biometric sensor may be a fingerprint reader, an iris scanner, a palm reader, a palm vein reader, a camera for scanning a body part or a body feature, or another type of biometric sensor. The coupler may include one or more screws that mate with threads of the second frame. The coupler may also include one or more wheels to turn the one or more screws to removably couple and uncouple the first frame and the second frame. The coupler may have a different structure in another embodiment.

### BRIEF DESCRIPTION OF THE DRAWINGS

FIG. 1 shows an embodiment of mobile biometric apparatus.

FIG. 2 shows a side view of the mobile biometric apparatus.

FIG. 3 shows an embodiment of a connector for a biometric module.

FIG. 4 shows an example of a biometric application running on a mobile terminal.

FIG. 5 shows another embodiment of a mobile biometric apparatus in a coupled state.

FIG. 6 shows the mobile biometric apparatus of FIG. 5 in an uncoupled state.

FIG. 7 shows an embodiment of a module of the mobile biometric apparatus.

### DETAILED DESCRIPTION

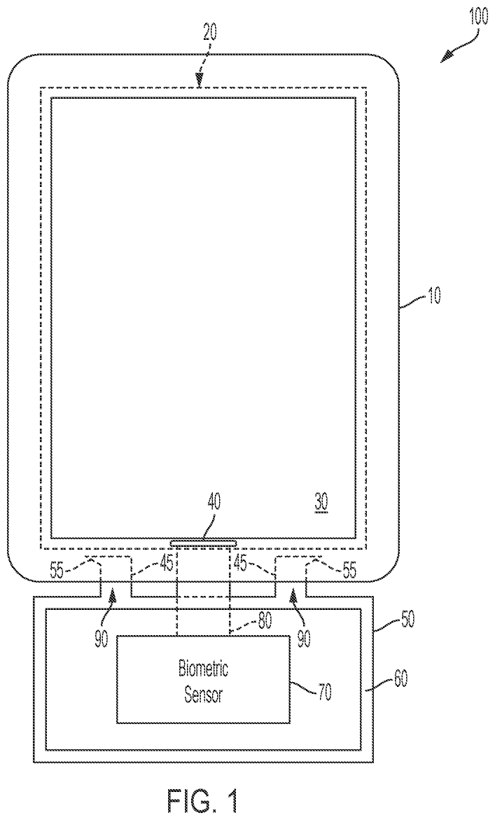

FIG. 1 shows an embodiment of a mobile biometric apparatus 100 for collecting and processing biometric information for various applications. The mobile biometric apparatus 100 may serve as a valuable tool for use by police, Homeland Security personnel, Border Patrol officers, intelligence agents, Social Services representatives, Department of Defense employees, and military professionals in identifying subjects in real-time. The mobile biometric apparatus 100 may also be used for controlling access to restricted areas, authenticating parties in financial transactions, verifying identity for purposes of medical treatment, transportation, voting, maintenance, package delivery, network or computer access, or performing other applications where security is of interest.

Referring to FIG. 1, the mobile biometric apparatus 100 includes a first frame 10 and a module 50. The first frame 10 supports or is otherwise coupled to a mobile terminal 20, which includes a display screen 30 and circuits for storing operating system software, applications including a biometric application, and data including information received from the module 50. The mobile terminal 20 may also include processing circuits and a communication interface for carrying out biometric information exchange and identification.

The communication interface may allow for wireless network access to one or more databases storing biometric information of persons of interest. The biometric information collected by the mobile biometric apparatus 100 may be compared with the biometric information (e.g., by internal circuits of the mobile terminal 20, a remote server, or both) stored in the databases for identification purposes. The databases may be maintained by a governmental (e.g. FBI, military, homeland security, etc.) or private entity. In one embodiment, the mobile terminal 20 may include or be coupled to a memory or other device storing biometric information for comparison to the collected biometric information. In this latter embodiment, the mobile biometric apparatus 100 may be considered to be a stand-alone device.

The mobile terminal 20 may be any type of a commercially available data terminal. Examples include but are not limited to a smart phone, tablet, handheld computer, personal digital assistant, or another type of information or data terminal. In one embodiment, the mobile terminal 20 may be a specially dedicated device for collecting and processing biometric information for subject identification or authentication.

In order to provide enhanced protection, the first frame 10 may surround and cover edges of the mobile terminal 20 and may be made, for example, of a polycarbonate or composite material sufficiently rigid to withstand shock, vibration, or external impact that may damage the mobile terminal 20. When constructed in this manner, the first frame 10 may be considered to be part of a ruggedized device suitable for use by professionals in the field. The first frame 10 may surround or cover all edges of the mobile terminal 20 or fewer than all edges (e.g., two or three edges), or may be fastened to a back surface of the mobile terminal 20. In one embodiment, a protective transparent cover may stretch across the frame 10 in order to seal the mobile terminal 20 from moisture, dust, corrosion, or other environmental influences.

The frame 10 may include openings, open edges, or recesses to allow for access to or to provide clearance for controls (e.g. volume, on/off buttons, etc.), a camera, sensors, a charging/accessory port, or other features of the mobile terminal 20. In FIG. 1, a charging/accessory port 40 is shown for illustrative purposes.

In addition, one or more features may be included that allow module 50 to be coupled to the frame 10. These features may be incorporated into the frame 10 or may be placed on the frame to provide a secure mechanical coupling between the frame 10 and module 50. Such a coupling may be considered to increase the rugged properties of the mobile biometric apparatus 100.

The coupling between the frame 10 and module 50 may be accomplished in various ways. For example, the frame 10 may include features that allow module 50 to snap, screw, hook, connect to, mate with, or fasten to features on the frame 10. Additionally, or alternatively, the frame 10 may include a recess that allows for a friction fit with portions of module 50. In the example of FIG. 1, frame 10 includes holes 45 for receiving projections 55 extending from the module 50. The ends of the projections 55 have angled surfaces that allow the projections 55 to lock into respective ones of the holes 45. Thus, the module 50 may be removably coupled to the frame 10. Removable coupling of module 50 to frame 10 may facilitate removal and/or replacement of mobile terminal 20 by a user, for example in case of malfunction or obsolescence, or for convenience during storage or transport, without requiring disassembly of module 50. A release may be included to deflect one or both of the projections to allow for removal of the module 50 from the frame 10. In another embodiment, the coupling may be permanent. Also, in FIG. 1, the module 50 is coupled to a lower edge of the frame 10. In another embodiment, the module 50 may be coupled to a different edge or surface of the frame 10.

The module 50 includes a second frame 60, a biometric sensor 70, an electrical connector 80, and a coupler 90. The second frame 60 supports and secures the biometric sensor 70 in a stable position and may be made of the same or a different material from the frame 10. For example, the second frame 60 may be made of a polycarbonate or composite material sufficiently rigid to withstand shock, vibration, or external impact that may damage the biometric sensor 70. When constructed in this manner, the module 50 may also be ruggedized and, thus, suitable for use by professionals in the field.

The second frame 60 may surround or cover all edges of the biometric sensor or fewer than all edges (e.g., two or three edges), or may be fastened to a back surface of the mobile terminal 20. In one embodiment, a protective transparent cover may stretch across the second frame 60 in order to seal the biometric sensor 60 from moisture, dust, corrosion, or other environmental influences. In one embodiment, the module 50 may exclude the second frame 60 altogether and a casing or housing of the biometric sensor 60 may be attached directly to the first frame 10 and equipped with or otherwise modified to include electrical connector 80 and coupler 90.

In one embodiment, the size of the second frame 60 may correspond to a size or dimension of the first frame 10. For example, as shown in FIG. 1, the width of the second frame 60 is the same as the width of the first frame 10. The second frame 60 may have a different size or different dimensions in other embodiments. Overall, the module 50 may be smaller than the frame 10, but this may not be the case depending, for example, on the type of biometric sensor 70 supported by the second frame 60.

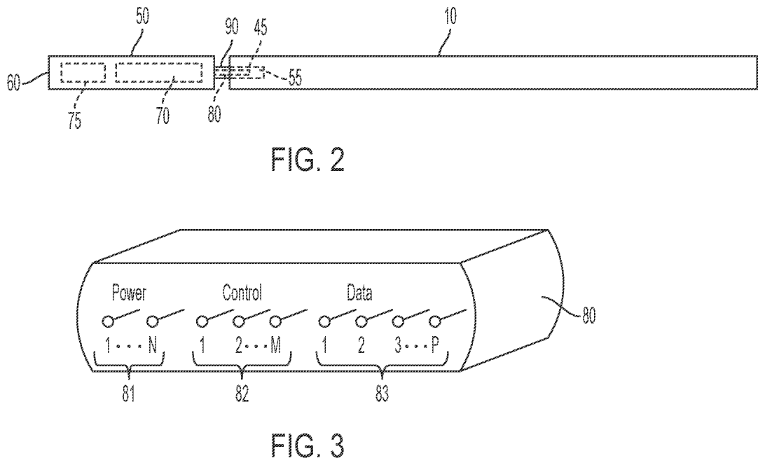

FIG. 2 shows an example of aside view of the mobile biometric apparatus 100. As shown in FIG. 2, the second frame 60 of the module 50 and the first frame 10 of the mobile terminal 20 have the same thickness. When the thicknesses of the first frame 10 and second frame differ by less than 20% of the thickness of the first frame, the first frame 10 and the second frame 20 may be considered to have substantially the same thickness. The same may be true of the width and height of the two frames 10 and 60. Also, as shown in FIG. 2, the upper surfaces of the first frame 10 and the second frame 60 are coplanar. This may make the mobile biometric apparatus 100 easier to use, and this is especially the case when the two frames 10 and 60 are coplanar.

The biometric sensor 70 may be any of a variety of biometric sensors. Examples include a fingerprint reader, a palm reader, a palm vein reader, an iris scanner, a camera for recognition of a body part or body feature (e.g., face, body defects or peculiarities, tattoos, etc.), retina scanner, a microphone for voice recognition, or a sensor for collecting another type of biometric information.

As shown in FIG. 1, the biometric sensor 70 has a sensing surface oriented in a same direction as the display screen 30 of the mobile terminal 20. The sensing surface may be a fingerprint pad in the case of a fingerprint reader, a camera in the case of an iris scanner, etc. The matching orientation of the biometric sensor 70 increases efficiency of use since the apparatus 100 does not have to be flipped over in order to obtain biometric information from the subject of interest. Rather, a user may immediately determine whether the biometric information captured by sensor 70 is acceptable (or whether another scan or capture is required) simply by viewing the information on the display screen 30.

FIG. 3 shows an embodiment of an internal configuration of the electrical connector 80. As previously described, electrical connector 80 carries various signals between the biometric sensor 70 and the mobile terminal 20. These signals may include power signals, control signals, and/or data signals. The electrical connector 80 may include signal lines, pins, or contacts corresponding to each type of signal (generally referred to as lines below).

As shown in FIG. 3, electrical connector 80 has N power lines 81, M control lines 82, and P data lines 83. The numbers of N, M, and P may be the same or different. The power lines 81 carry power from the mobile terminal 20 to power the biometric sensor 70. This power may be derived from the battery of the mobile terminal 20 and/or power from a charger, if the mobile terminal is charging. By powering the biometric sensor 70 based on power from the mobile terminal 20, the biometric sensor 70 is not required to have its own battery or power source. Thus, the biometric sensor 70, or module 50, does not have to be charged separately. This increases efficiency and costs. In one embodiment, biometric sensor 70 is powered only based on the battery power from the mobile terminal 20 passing through the electrical connector 80.

The control lines 82 carry control signals from the mobile terminal 20 to the biometric sensor 70. The control signals may be generated by a biometric application running on the mobile terminal 20. For example, when such a biometric application is selected (or otherwise activated) by a user, the application may generate control signals to activate the biometric sensor and then place the sensor in a mode for receiving or collecting biometric information. The control signals may then instruct the sensor to send the captured or collected biometric information to the mobile terminal 20 for processing, storage, transmission to a remote server, matching, and/or to perform another function.

The data lines 83 carry the biometric information captured or collected by the biometric sensor 70 to the mobile terminal 20. The biometric information may be carried on the data lines 83 in various ways, e.g., a sampled digital form corresponding to a predetermined template. The template may be, for example, a fingerprint template, iris template, face template, etc. In one embodiment, the mobile terminal may packetize the biometric information received from the data lines 83 for encrypted secure transmission to a remote server for matching with biometric information stored in a database.

The specific type of electrical connector 80 used may be determined, for example, based on the type of charging/accessory port 40 of the mobile terminal 20. When the mobile terminal is a smart phone, the electrical connector 80 may be a port connector of the smart phone. For example, when the mobile terminal 20 is an Android phone (e.g., Samsung Galaxy), the electrical connector 80 may be or conform to a USB-C type connector. When the mobile terminal 20 is an iPhone, the electrical connector 80 may be or conform to a Lightning-type connector.

Referring again to FIGS. 1 and 2, the electrical connector 80 (e.g., plug) extends or protrudes from a side surface of the second frame 60 of the module 50 without an intervening cable. The omission of a cable, and the direct coupling between connector 80 and the mobile terminal 20, allows for a more compact design. It also promotes stability and makes the entire apparatus 100 easy to carry and wearable on a belt in an integrated, compact manner. The electrical connector 80 may be directly connected to the biometric sensor 70 within the second frame 60, or one or more intervening circuits may be included in the second frame 60 to perform conversion, signal processing, and/or control functions in order to place the captured biometric information in a form compatible for transmission through the electrical connector 80 and/or through a network.

The coupler 90 secures the physical coupling of the module 50 to the first frame 10 of the mobile terminal 20. As previously discussed, the coupler 90 may mate or otherwise combine with features on the first frame 10 to establish a secure connection. Connecting the electrical connector 80 to the charging/accessory port 40 of the mobile terminal 20 may assist in this process. For example, aligning the electrical connector 80 with the port 40 may cause the coupler 90 to be aligned with the features on the first frame 10 to establish the physical coupling between the module 50 and the first frame 10, e.g., projections 55 may be aligned with holes 45 when connector 80 is aligned with port 40.

Also, as previously discussed, the physical coupling between the module 50 and the first frame 10 (or, more specifically, between first frame 10 and second frame 60) may be a removable coupling. In this case, aligning and mating the coupler 90 with companion features on the mobile terminal 20 for physical coupling automatically results in electrical connector 80 being inserted into port 40 of the mobile terminal. Conversely, removing the physical coupling between the first frame 10 and the second frame 60 will automatically cause the electrical connector to be disconnected from the port 40 of the mobile terminal. The interdependent relationship between this physical coupling and electrical connection may not exist in another embodiment.

In one embodiment, the module 50 may include at least one additional biometric sensor (e.g., 75 in FIG. 2) for collecting biometric information different from biometric sensor 70. Such an embodiment may be suitable for many military applications, where, for example, both fingerprint and iris scans are required for identification. The additional biometric sensor 75 may be incorporated in the second case 60 with biometric sensor 70 or may be coupled to the second case 60. The additional biometric sensor 75 may have a sensing surface in the same orientation (e.g., direction) as the sensing surface of biometric sensor 70 and display screen 30, or may be at indifferent orientation, e.g., attached to a back or side surface of the second frame 60.

The power for the additional biometric sensor 75 may also be derived from the power (e.g., the battery or charging power) of the mobile terminal 20. This may be accomplished, for example, by connecting a power splitter circuit to the power lines 81 of the electrical connector, and then routing power to the respective biometric sensors 70 and 75.

In operation, a user selects a biometric application icon on the display screen 30 of the mobile terminal 20. Selection of this icon initiates display of a main screen of the biometric application. The main screen includes a number of selectable menu options for obtaining biometric information from a subject. The biometric information that may be obtained may be one or more of the types of biometric information previously described.

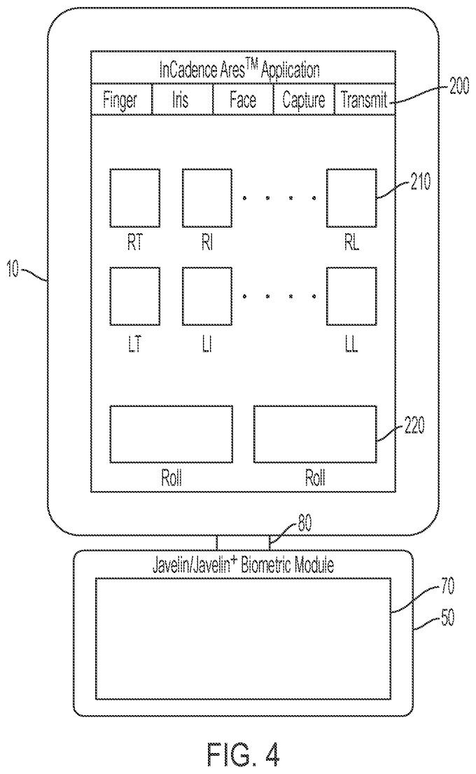

FIG. 4 shows an example of a menu bar 200 indicating selectable options for obtaining fingerprints, an iris scan, and facial recognition information. When a user selection is received, a screen is displayed showing, for example, an empty template corresponding to the biometric information to be obtained. In the case of FIG. 4, the screen shows ten boxes 210 for respective ones of ten fingerprints of a subject. The boxes are presented in a predetermined sequence and are displayed with additional boxes 220 for rolling fingerprints.

When the empty template is displayed, the user may select the option “capture” on the menu bar. When this option is selected, biometric application program running on the mobile terminal may send power and control signals through the electrical connector 80 to place biometric sensor 70 (in this case, a fingerprint reader) in capture mode. The user may then begin reading the fingerprints, in sequence, of the subject to be identified. The captured biometric information (fingerprint scans) are then digitized and sent, through the data lines of the electrical connector 80, to the mobile terminal. The biometric application program then displays the fingerprints. A similar process may be carried out for capture of other types of biometric information. When multiple biometric sensors are included in module 50, selection of the type of biometric data to be captured on menu bar 200 may cause the corresponding sensor to be powered and initiated.

If the user determines the fingerprints to be acceptable, the “transmit” option on the menu bar 200 may be selected. When this option is selected, the fingerprints are transmitted to an external database through a wireless network for comparison to fingerprints information in that database. The results of the comparison are then communicated back to the mobile terminal 20, indicating whether a match was found and the identity of the subject if there was a match. When multiple biometric sensors are included in module 50, this operation may be performed sequentially for each type of biometric.

The use of such a biometric application running on a mobile terminal allows for real-time, in-the-field identifications to be made. Also, the control software of the application may be written so that updating the biometric application on the mobile terminal 20 will automatically result in updating the control software of the biometric sensor(s). This alleviates the need to update the software of the biometric(s) separately.

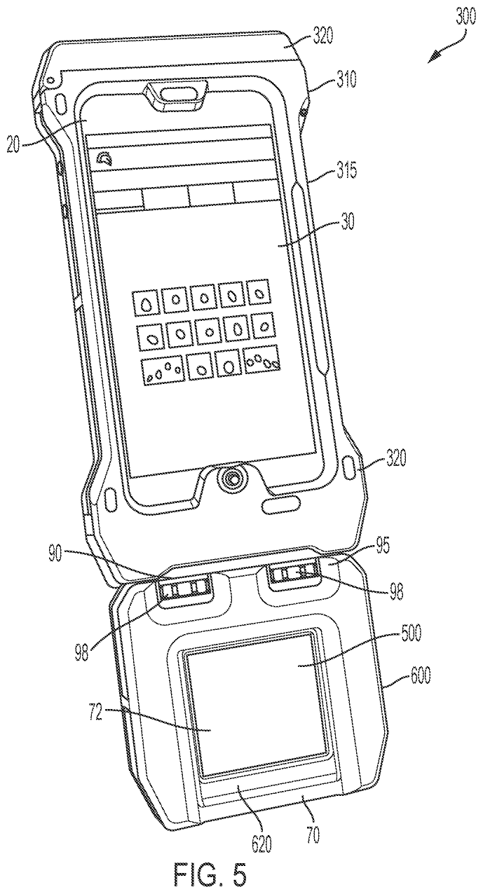

FIGS. 5, 6, and 7 show another embodiment of a mobile biometric apparatus 300, which is similar to the mobile biometric apparatus 100 of FIG. 1 with at least the following exceptions. The same reference numerals are used to identify similar features.

The mobile biometric apparatus 300 includes a first frame 310 supporting a mobile terminal 20. Unlike the first frame 310 of the FIG. 1 embodiment, first frame 310 is ergonomically shaped to fit the hand of a user and thus to be easier to use. The shape includes a central portion 315 and flange portions 320. The central portion 315 has a smaller width than the flange portions to allow the fingers of a user to firmly grip the apparatus 300. The flange portions 320 help to prevent the user from dropping the apparatus 300 when, for example, the subject tries to hit the user or the user otherwise has slippery fingers. The surface of the first frame 310 may be made to be made grainy to further enhance the grip of the user.

The mobile biometric apparatus 300 in FIG. 5 is shown in a coupled state, e.g., a state where module 500 including biometric sensor 70 is coupled to the first frame 310 of the mobile terminal 20. In this coupled state, the electrical connector (e.g., plug) 80 of the module 500 is inserted into the charging/accessory port 40 of the mobile terminal 20. In this example, the mobile terminal is a Samsung Galaxy phone and the biometric sensor 70 is a Watson Mini multi-fingerprint scanner from Integrated Biometrics, LLC. Such a fingerprint scanner is compatible with FBI Appendix F and PIV standards. As a result, fingerprints scanned by biometric sensor 70 may be compared against the FBI fingerprint records for purposes of subject identification. The same fingerprints are compatible for searching the records of military databases and other applications.

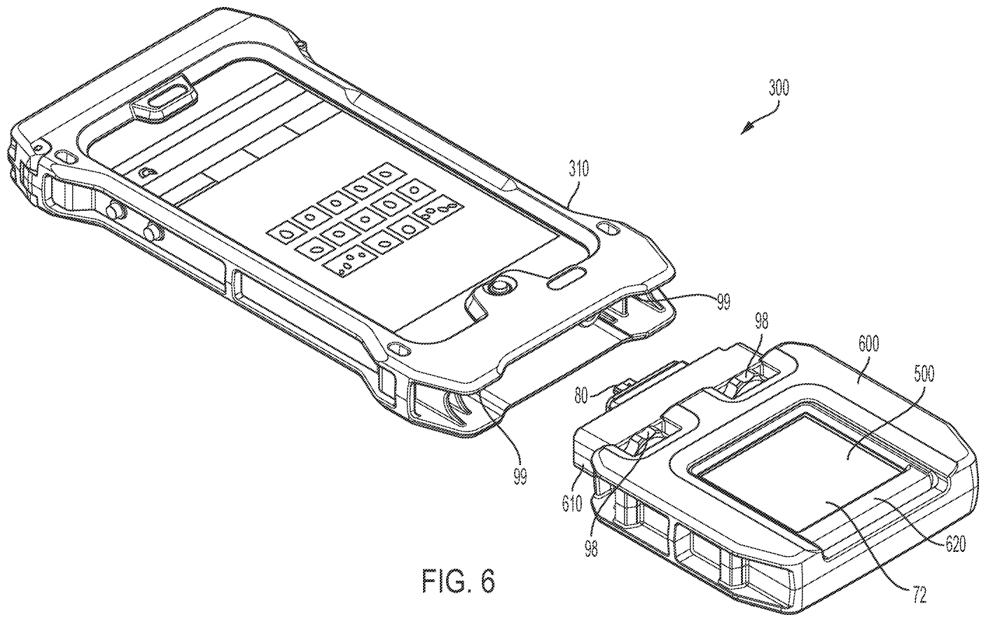

The mobile biometric apparatus 300 in FIG. 6 is shown in an uncoupled state, e.g., a state where module 500 is uncoupled from the first frame 310 of the mobile terminal 20. In this state, the USB-C type connector 80 is shown as protruding from the second frame 600 of the module 500. A section 610 of the module (which may or may not be part of the second frame 600) also extends from the second frame and is situated between the exposed portion of connector 80 and the fingerprint scanner 70. Section 610 houses portions of a coupler 90 used to couple the second frame 600 to the first frame 310 of the mobile terminal 20. As shown in FIG. 6, the section 610 may overlap a portion of the first frame 610 in the coupled state in order to increase the rigidity and stability of the coupling.

The second frame 600 includes a recessed portion 620 to allow the fingers of a subject to more easily access the sensing surface 72 of the fingerprint scanner 70. The width of the recessed portion may be sized to accommodate only one finger or may be sized to accommodate two or more fingers on the sensing surface 72 of the fingerprint scanner 70. The recessed portion 620 may serve to increase the accurate placement of fingers on the sensing surface 72 and thus the chances of obtaining clear and accurate fingerprints.

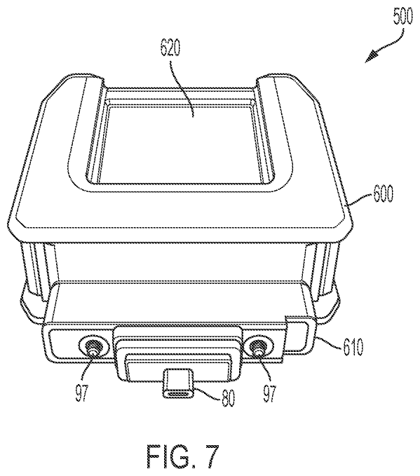

The coupler 90 of the module 500 is in the form of a wheel-and-screw arrangement 95. As shown in FIG. 7, this arrangement has two screws 97 situated on respective sides of the USB-C type plug 80. The screws 97 are attached, within section 610, to corresponding wheels 98 (see FIGS. 5 and 6). When the wheels are turned in a first direction, the screws extend out of section 610 to catch threads in holes 99 aligned in the frame 310 of the mobile terminal 20, thereby coupling second frame 600 to first frame 310. Turning the wheels 98 in the first direction, therefore, simultaneously and automatically causes plug 80 to be aligned with and connected to port 40 of the mobile terminal. Turning the wheels 98 in a second direction (opposite to the first direction) decouples second frame 600 from first frame 310, and simultaneously and automatically disconnects plug 80 from port 40.

In addition to the foregoing features, module 500 may include or be coupled to at least one additional biometric sensor. That sensor may be, for example, an iris scanner, a camera for recognition of body parts or body features, or another type of biometric sensor including but not limited to the ones previously described. One example of an iris scanner that may be included or coupled to module 500 is the MK2120U scanner by Iritech, Inc. In one embodiment, one or more additional biometric sensors may be included or coupled to the frame of the mobile terminal.

The methods, processes, and/or operations in connection with the biometrics application program, operating system software, and other programming features of the embodiments described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing the methods described herein.

The controllers, processors, and other signal processing features of the embodiments described herein may be implemented in non-transitory logic which, for example, may include hardware, software, or both. When implemented at least partially in hardware, the controllers, processors, and other signal processing features may be, for example, any one of a variety of integrated circuits including but not limited to an application-specific integrated circuit, a field-programmable gate array, a combination of logic gates, a system-on-chip, a microprocessor, or another type of processing or control circuit.

When implemented in at least partially in software, the controllers, processors, and other signal-processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods described herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments or operations of the apparatus embodiments described herein.

Any reference in this specification to an “embodiment” means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments. The features of any one embodiment may be combined with features of one or more other embodiments described herein to form additional embodiments.

Although the present invention has been described herein with reference to a number of illustrative embodiments, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

1: A mobile biometric apparatus, comprising:
a first frame to support a mobile terminal, and
a module comprising a second frame to support a first biometric sensor having a sensing surface oriented in a same direction as a display screen of the mobile terminal,
wherein the module further comprises:
a coupler to removably couple the second frame to the first frame, and
a connector to deliver power from the mobile terminal to the first biometric sensor and to exchange a signal between the first biometric sensor and the mobile terminal,
wherein the signal comprises biometric information from the first biometric sensor and
wherein the connector comprises a plug to be inserted into a port of the mobile terminal when the first frame is coupled to the second frame and separated from the port of the mobile terminal when the first frame is uncoupled from the second frame.

2: The apparatus of claim 1, wherein the plug extends from a side surface of the module with no intervening cable.

3: The apparatus of claim 1, wherein the first frame has an upper surface which is coplanar with an upper surface of the second frame.

4: The apparatus of claim 1, wherein the first case is to support the mobile terminal at a level coplanar with the first biometric sensor to be supported by the second case.

5: The apparatus of claim 1, wherein the first biometric sensor is to be powered only based on the power from the mobile terminal passing through the connector.

6: The apparatus of claim 1, wherein the signal comprises one or more control signals output from the mobile terminal to operate the first biometric sensor.

7: The apparatus of claim 1, wherein the second frame is smaller than the first frame.

8: The apparatus of claim 1, wherein the first frame and the second frame are made of a polycarbonate material.

9: The apparatus of claim 1, wherein the mobile terminal is a smart phone, a tablet, a handheld computer, or a personal digital assistant.

10: The apparatus of claim 1, wherein the first biometric sensor is a fingerprint reader, a palm reader, a palm vein reader, an iris scanner, a retina scanner, a microphone for voice recognition, or a camera for recognition of a body part or body feature.

11: The apparatus of claim 1, wherein the second frame of the module is to support a second biometric sensor.

12: The apparatus of claim 11, wherein the second frame is to support the second biometric sensor having a sensing surface oriented in the same direction as the display screen of the mobile terminal and the sensing surface of the first biometric sensor.

13: The apparatus of claim 11, wherein the first biometric sensor and the second biometric sensor are to sense different biometric information.

14: The apparatus of claim 1, wherein the coupler comprises one or more screws to mate with threads of the first frame.

15: The apparatus of claim 14, wherein the coupler comprises one or more wheels to turn the one or more corresponding screws to removably couple and uncouple the second frame to the first frame.

16-24. (canceled)
